(19) United States
(12) Patent Application Publication
(10) Pub. No.: US 2002/0108064 A1
(43) Pub. Date: Aug. 8, 2002

(54) System and method for optimizing power/performance in network-centric microprocessor-controlled devices

(76) Inventor: Patrick Nunally, Escondido, CA (US)

Correspondence Address: KNOBBE MARTENS OLSON & BEAR LLP, 620 NEWPORT CENTER DRIVE, SIXTEENTH FLOOR, NEWPORT BEACH, CA, 92660, US

(21) Appl. No.: 09/779,395

(22) Filed: Feb. 7, 2001

(51) Int. Cl. G06F 1/26; G06F 1/28; G06F 1/30

(52) U.S. Cl. 713/300

(57) ABSTRACT

A method and system for controlling the speed of a microprocessor in a microprocessor-controlled device when executing an application program retrieved from a remote repository. The program retrieved contains embedded instructions related to the processing power required to execute the program and maintain a specified quality of performance. The processor speed is adjusted consistent with the embedded instructions so that when necessary, the processor can function at a higher speed, consuming greater power, and when not necessary, the processor can return to consuming lower power at a low-speed state, to thereby conserve battery resources.

### BACKGROUND OF THE INVENTION

1. Field of the Invention

This invention relates to microprocessor-controlled devices, and, more particularly, to a system and method for optimizing power/performance in network-centric microprocessor-controlled devices.

2. Description of the Related Art

With the advent of low cost, high-density integrated circuits, battery-powered microprocessor-controlled devices have become increasingly popular. Examples of battery-powered, microprocessor-controlled devices are portable Internet-linked tablets of the type employed as personal information devices and Internet-enabled cell phones. It is often desirable to download software programs from the Internet using such devices. One major limitation of these devices is the limited battery life.

Sun Microsystems, Inc.'s Java (“JAVA” is a trademark of Sun Microsystems, Inc.) programming language has emerged as an industry-recognized language for “programming the Internet.” The Java technology comprises primarily (i) a new programming language—somewhat similar to C and C++—and (ii) a virtual machine. Essentially, programs written in the Java programming language can be compiled into byte code form and then interpreted at runtime on the Java virtual machine (VM), also known as a Java runtime engine, executing on the client. The Java VM converts the byte codes into instructions that can be executed by the underlying physical machine. Unlike traditional computer programs, which are almost always compiled for a hardware platform using tools that preclude their running on anything else, Java applications can be designed to run on any system that has a Java VM. The VM takes Java byte code and transforms it on the fly into instructions that can be executed by the PC. The same byte code can be interpreted as hardware-level instructions for any other platform with a VM implementation.

Programs written using Java can be downloaded over the Internet in the form of byte codes for execution on a Java VM at the client. Such programs are known as “applets”. Java applets are small, specialized applications that comply with Sun's Java Application Programming Interface (API) allowing developers to add “interactive content” to Web documents (e.g., simple animations, page adornments, and basic games). Applets execute within a Java-compatible browser (e.g., Netscape Navigator) by copying code from the server to the client. It will be noted that the concept of downloading software from a server to a client in the form of byte codes for execution on a virtual machine was also known independently of the Java technology (see for example U.S. Pat. No. 5,347,632).

Running these applets on battery-powered microprocessor-controlled devices can be taxing on battery life and processing power. Some applets require a higher level of processor performance than the processor normally provides in order to run at a desired quality level. If the processor does not provide this required level of performance, the applet will not perform at the desired quality level. The processors in such devices often have the capability to provide sufficient performance; however, running at this faster speed creates a significant drain on the battery, thus creating unacceptable battery life. Such devices are not useful in a practical sense if the battery life is too short. Of course, battery life may be extended by improving the batteries themselves or by providing more batteries in the device. However, such improvements to the batteries often increase the cost, size and/or weight of the device.

It is known in the art to employ systems with two processors having different characteristics. For example, U.S. Pat. No. 4,677,433 to Catlin et al. entitled Two-Speed Clock Scheme For Co-Processors discloses a system including two processors, one of which is a high-speed microprocessor, the other of which is a low-speed numeric data processor. The system runs at low speed when both processors must be used and runs at high speed when only the microprocessor needs to be used. A source control provides a high- or low-speed clock via a clocking generator that is coupled to both processors. There is no suggestion to use such a system for power conservation.

It is also known in the art to operate a microprocessor at two speeds to conserve power. For example, U.S. Pat. No. 4,254,475 to Cooney et al. entitled Microprocessor Having Dual Frequency Clock discloses a power conservation system in which a microprocessor operates at low speed until a sensor is activated or predetermined time duration has passed. When either of these events occurs, the high-speed clock is activated.

It is desired to have a method and system that allows a processor to tailor its resource requirements to run a program received from a remote source, thereby allowing the processor to dynamically shift to higher power, higher speed clock rates for performing key program tasks and achieve a desired level of performance. It is also desired that the processor return to a lower power, low-speed clock rate for performing localized tasks after specific program functions such as multimedia are complete so that unnecessary drain on the battery is reduced.

### SUMMARY OF THE INVENTION

One embodiment of the invention comprises a system and method in which a microprocessor-controlled device employs a single processor and an API which allow for execution-specific allocation of processor resources (such as clock speed) as needed to execute multimedia and like object oriented programs. Prior to network-born external requests, microprocessors act in accordance with local processing operation, ideally encompassing a low-power, low-performance, low-speed clock rate for performing localized tasks. Upon request from an externally provided application (typically introduced via a network), the microprocessor clock speed is increased, effectively resulting in a higher power, higher performance processor that may run at one of several high speeds for performing computationally intensive tasks as required by the application. Power is thereby conserved.

According to yet another aspect of the invention, the high-speed processor may run at variable clock speeds, with power consumption of the processor increasing with increasing speed. According to another aspect of the invention, the high-speed processor may select its own clock speed based upon the task to be performed or may be instructed to operate at a given clock speed by the network-born program. This may be accomplished, according to the invention, by including a clock speed metric in each subroutine, preferably at the beginning of the subroutine.

As described above, battery life may be extended by providing a high-performance processor, which is activated by a low-performance processor depending upon the task to be performed, and by providing self-control of the high-performance processor speed. It will be recognized by those having skill in the art that each of the above-described features may be employed separately or in connection with other features in order to extend battery life. It will also be recognized that the above-described combination of features provides a system that is uniquely capable of performing computationally intensive yet temporal foreground tasks or background tasks with minimal power drain.

This invention provides a method of controlling the speed of a microprocessor so that its processing power is sufficient to run a program at the time of execution by including embedded instructions as part of the program. Thus, a predetermined level of performance quality is maintained. The method includes embedding operating speed instructions in a program to be used by a microprocessor, executing the program by the local microprocessor, reading the embedded instructions locally and provisionally adjusting the operating clock speed of the local microprocessor from a first speed to a second speed in accordance with the instructions such that sufficient processing power is provided to achieve a predetermined level of performance in executing the program.

### BRIEF DESCRIPTION OF THE DRAWINGS

These and other objects and features of the invention will become more fully apparent from the following description and appended claims taken in conjunction with the following drawings.

FIG. 1 is a block diagram of a microprocessor-controlled device for use with an embodiment of the invention.

FIG. 2 is a block diagram of a network including the microprocessor-controlled device of FIG. 1.

FIG. 3 is a block diagram of a method for controlling the operating speed of the microprocessor of FIG. 1.

### DETAILED DESCRIPTION OF THE INVENTION

The following presents a detailed description of certain specific embodiments of the invention. However, the invention can be embodied in a multitude of different ways as defined and covered by the claims. In this description, reference is made to the drawings wherein like parts are designated with like numerals throughout.

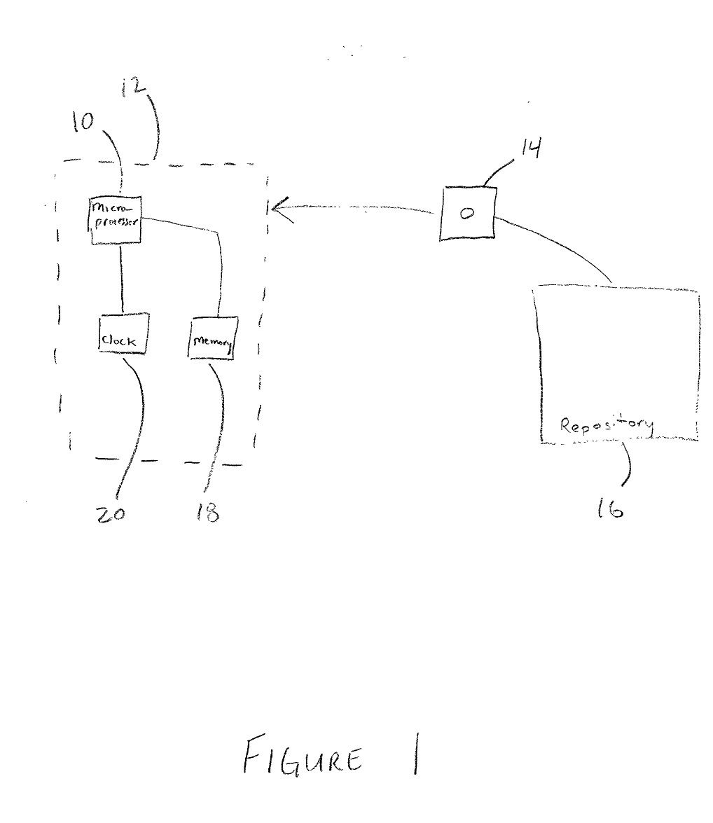

FIG. 1 presents an overview of one embodiment of the invention, which provides a method and system for controlling the speed of a microprocessor 10 in a microprocessor-controlled device 12 when retrieving an application program 14 from a remote repository 16. Prior to requesting the application program 14, the microprocessor 10 acts in accordance with local processing parameters, operating at a low-power, low-performance, low-speed clock rate for performing localized tasks. The application program 14 contains embedded instructions relating to the processing power required to run the program and meet a desired quality of performance. In one embodiment, the embedded instructions contain the clock speed necessary to run the program at the acceptable level. In another embodiment, the embedded instructions contain the number of millions of instructions per second (MIPS) required to run the program.

The application program 14 is received by the microprocessor-controlled device 12 and stored in a memory 18 and prepared for execution. Upon receiving the instructions, the processor 10 directs a clock 20 to shift to a high-power, high-performance, high-speed clock rate for performing computationally intensive tasks as required by the program to achieve a desired level of performance. Alternately, the processor 10 can select whether to modify current operating parameters so that the processor is able to provide the performance required to obtain the predetermined desired quality of performance. The processor 10 may run at variable clock speeds, with power consumption of the processor increasing with increasing speed. Upon completion of the application program, the clock 20 is directed to revert to the original frequency.

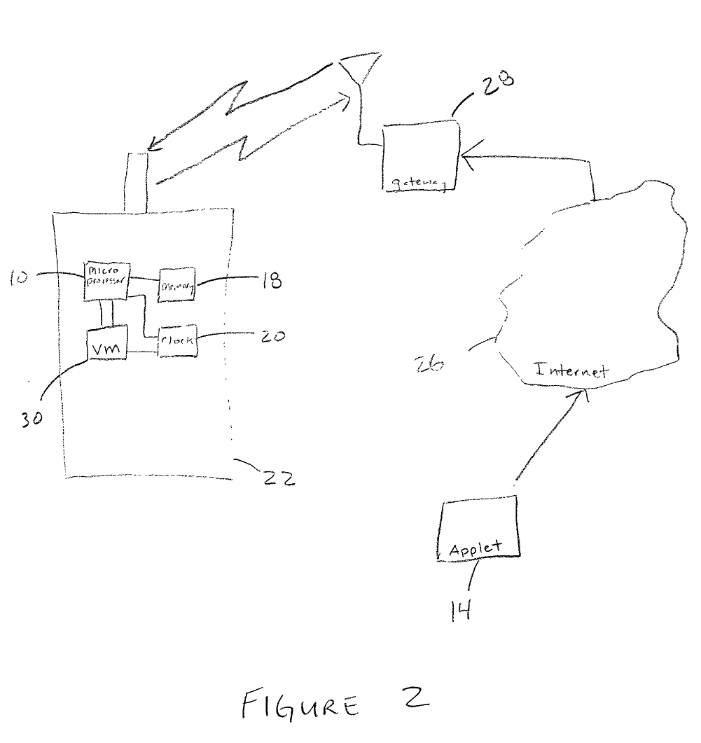

With reference to FIG. 2, in one embodiment, the application program 14 is a Java applet stored in a remote repository. A wireless communication device 22 containing a microprocessor 10 requests the applet 14 across a wireless link 24. The applet is delivered across a network 26, such as the Internet, through a service provider gateway 28 to the wireless communication device 22. The wireless communication device 22 stores the applet in the memory 18. The wireless communication device 22 includes a Java VM 30 running on the microprocessor 10. Upon execution, the VM 30 receives the instructions embedded in the applet 14 and directs clock 20 to run at an increased speed.

For example, the microprocessor 10 of the wireless communication device 22 may be initially running at an operating speed of 2 MHz. The applet 14 is delivered to the wireless communication device 22 across the wireless link 24. The applet contains a multimedia application and requires an operating speed of at least 4 MHz in order to run at a predetermined level of quality. Upon execution, the applet 14 requests an operating speed of 4 MHz to run at the predetermined level of performance quality. The processor 10 directs the clock 20 to increase clock speed so that the requested operating speed is achieved. In some applications local users will be provided with the ability to override the embedded performance metrics and in still other cases local algorithms may be allowed to scale overall performance and resource allocation of a given applet based on the embedded performance metrics provided by this invention.

The requested operating speed of the processor 10 can be determined based on a measurement of the number of instructions per second that need to be processed to achieve the predetermined level of quality. In one embodiment, the predetermined level of quality is determined by the creator of the applet 14. For example, the creator of the applet 14 may determine that it is desirable to have a frame update a certain number of times per second. The creator then can calculate the necessary operating speed based on the product specifications of the processor 10.

While the above example describes the invention with reference to a wireless communication device, it is understood that the invention may be implemented in any microprocessor-controlled device running programs received from remote sources. For example, programs stored on a memory card for use in an MP3 music player can be encoded with processor instructions directing the processing capabilities of the microprocessor of the player.

In one embodiment, the instructions may be coded in the applet 14 early in the program. For example, the instructions may be embedded in the first code line after the applet header. Alternatively the instructions could be placed in other locations in the applet, such as at the end. In another embodiment, the wireless communication device downloads more than one applet together as a bundle and the embedded instructions can be placed in the bundle heading.

It is conceived that the creator of the applet 14 can embed the instructions in the applet. Alternatively, the instructions can be embedded into program bundles during handling in the distribution channels or by the end user or recipient of the applet 14.

It is further contemplated that the microprocessor 10 may run more than one applet 14 simultaneously. In this case, the microprocessor 10 receives the embedded instructions from each of the individual applets 14 and determines if the aggregate of the applets requires the microprocessor 10 to run at a faster speed to deliver the desired quality of performance.

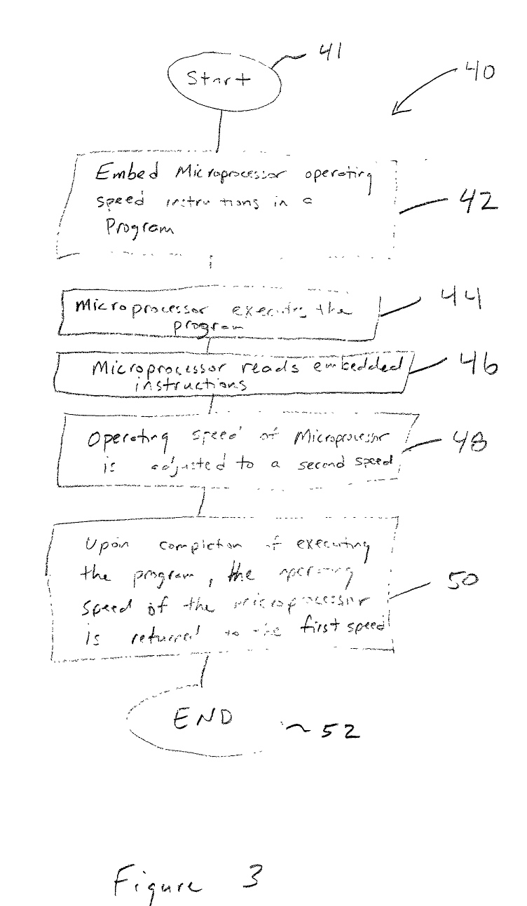

FIG. 3 displays a block diagram of a method 40 of controlling the operating speed of a microprocessor so that the microprocessor has sufficient processing power to run a program while a predetermined level of performance quality is maintained. The process proceeds from a start state 41 to a step 42, wherein operating speed instructions are embedded in the program 14 to be used by the microprocessor 10. In step 44, the program is executed by the microprocessor 10. In step 46, the microprocessor 10 reads the embedded instructions. In step 48, the microprocessor 10 adjusts the operating speed from a first speed to a second speed in accordance with the instructions such that sufficient processing power is provided to achieve the predetermined level of performance in executing the program. In step 50, upon completion of executing the program, the operating speed of the microprocessor 10 is returned to a lower speed, such as the first speed. The process then proceeds to a step 52 and terminates.

Specific blocks, sections, devices, functions and modules have been set forth. However, a skilled technologist will realize that there are many ways to partition the system of the present invention, and that there are many parts, components, modules or functions that may be substituted for those listed above. In the above example, the applet was requested and delivered across a wireless communication network. One skilled in the art can appreciate that the invention also discloses methods and systems of transferring the applet across wired links and also via an intranet, an Internet or any other form of network. Furthermore, other software languages such as C, C++, Pascal, VHDL, assembly or machine languages may be used in other embodiments.

While the above detailed description has shown, described, and pointed out the fundamental novel features of the invention as applied to various embodiments, it will be understood that various omissions and substitutions and changes in the form and details of the system illustrated may be made by those skilled in the art without departing from the intent of the invention.

What is claimed is:

1. A method of controlling the operating speed of a microprocessor in a microprocessor-controlled device so that the microprocessor has sufficient processing power to run a program while a predetermined level of performance quality is maintained, comprising:
embedding operating speed instructions in a program to be used by a microprocessor;
executing the program by the microprocessor;
reading the embedded instructions; and
adjusting the operating speed of the microprocessor from a first speed to a second speed in accordance with the instructions such that sufficient processing power is provided to achieve a predetermined level of performance in executing the program.

2. The method of claim 1, wherein the program is downloaded from a remote repository.

3. The method of claim 1, wherein the program is downloaded over a network.

4. The method of claim 1, wherein the program is downloaded over the Internet.

5. The method of claim 1, wherein the program is a Java applet.

6. The method of claim 5, where the embedded instructions are read by a Java Virtual Machine.

7. The method of claim 1, wherein the instructions are read by a hardware component.

8. The method of claim 6, wherein the applet contains a multimedia application.

9. The method of claim 1, further comprising returning the operating speed of the microprocessor from the second speed to the first speed after the program completes running.

10. The method of claim 1, wherein the instructions are embedded by the creator of the program.

11. The method of claim 1, wherein the instructions are embedded by the distributor of the program.

12. The method of claim 1, wherein the instructions are embedded by the recipient of the program.

13. The method of claim 1, wherein the program is stored on a memory card.

14. The method of claim 1, wherein the instructions define a suggested processor speed.

15. The method of claim 14, wherein the instructions bear information used by the processor to optimally execute the program.

16. The method of claim 1, wherein the instructions instruct the microprocessor to alter a clock speed.

17. The method of claim 1, wherein the instructions include a number of instructions per second that that are to be processed.

18. A method of controlling the speed of a microprocessor in a network-centric microprocessor-controlled device so that the microprocessor has sufficient processing power to run an applet while maintaining a predetermined level of performance, comprising:
embedding operating speed instructions in a Java applet to be used by a microprocessor;
executing the applet by a Java Virtual Machine coupled to the microprocessor;
reading the instructions embedded in the applet; and
adjusting the speed of the microprocessor in accordance with the instructions from a low-speed, low-power setting to a high-speed, high-power setting such that sufficient processing power is provided to achieve a predetermined level of performance in executing the applet.

19. The method of claim 18, wherein the applet is downloaded from a remote repository.

20. The method of claim 18, wherein the instructions instruct the microprocessor to alter a clock speed.

21. The method of claim 18, further comprising returning the operating speed of the microprocessor from the high-speed, high-power setting to the low-speed, low-power setting after execution of the applet.

22. The method of claim 18, wherein the instructions include a number of instructions per second that that are to be processed.

23. The method of claim 19, wherein the instructions bear information used by the processor to optimally execute the program.

24. A system for controlling the operating speed of a microprocessor so that the microprocessor has sufficient processing power to run a program while a predetermined level of performance quality is maintained, comprising:
means for embedding operating speed instructions in a program to be used by a microprocessor;
means for downloading the program so it can be executed by the microprocessor;
means for reading the embedded instructions; and
means for adjusting the operating speed of the microprocessor from a first speed to a second speed in accordance with the instructions such that sufficient processing power is provided to achieve a predetermined level of performance in executing the program.

25. The system of claim 24, wherein the instructions instruct the microprocessor to alter a clock speed.

26. The system of claim 24, wherein the instructions include a number of instructions per second that that are to be processed.
